(19) United States
(12) Patent Application Publication
(10) Pub. No.: US 2021/0400974 A1
(43) Pub. Date: Dec. 30, 2021

(54) METHOD OF CONTROLLING NEMATODES

(71) Applicant: Syngenta Crop Protection AG, Basel (CH)

(72) Inventor: Christopher Glen Clemens, Richland, WA (US)

(73) Assignee: Syngenta Crop Protection AG, Basel (CH)

(21) Appl. No.: 17/292,896

(22) PCT Filed: Nov. 5, 2019
(86) PCT No.: PCT/US19/59785

§ 371 Date: May 11, 2021

Related U.S. Application Data
(60) Provisional application No. 62/758,790, filed on Nov. 12, 2018.

(51) Int. Cl. A01N 43/90; A01N 25/02

(52) U.S. Cl. CPC A01N 43/90; A01N 25/02

(57) ABSTRACT

Methods for controlling nematodes in soil by delivering compositions of abamectin with high volumes of water through irrigation systems, such as center pivots and lateral irrigation systems having chemigation systems.

### FIELD OF THE INVENTION

The present technology relates to compositions comprising abamectin, and in particular the application of abamectin compositions with high volumes of water.

### DETAILED DESCRIPTION

The present technology relates to an improved method of controlling or suppressing nematodes in farm fields and soils in general. The present technology includes application of abamectin and/or compositions comprising abamectin with high volumes of water. Generally, this application will be made through an application system commonly known as a chemigation system. Chemigation systems are well-known in the industry and commonly used to apply fertilizers, pesticides, and other chemicals through an existing irrigation system. Examples of commercially available chemigation systems include GROWSMART™ by Lindsey Corporation of Omaha, Nebr. and systems sold by AGRI-INJECT of Yuma, Colo.

Chemigation systems can be used with any type of irrigation infrastructure, including hand-lines, wheel-lines, center pivot systems and lateral systems, but are most commonly used with center pivot and lateral irrigation systems that utilize a fixed water feed (e.g. center pivot), single water feed (e.g. hose-fed lateral system), or carry an integrated chemigation system.

In an embodiment of the present technology, a method of controlling or suppressing nematodes is achieved by applying a composition comprising abamectin at a rate of from 5 to 30 grams/acre in combination with the application of water applied at a rate of from 8,500,000 to 103,000,000 grams/acre.

The application of abamectin and water can be applied simultaneously or sequentially, or a combination thereof. While application applied simultaneously is expected, an application of abamectin followed by water is also envisioned. A combination application, may include, for example that the abamectin be simultaneously applied with 5,000,000 g water/acre followed by a second 5,000,000 g water/acre application.

In another embodiment of the present technology, a method of controlling or suppressing nematodes is achieved by applying a composition comprising abamectin at a rate of from 7 to 15 grams/acre in combination with the application of water applied at a rate of from 8,500,000 to 103,000,000 grams/acre.

In another embodiment of the present technology, a method of controlling or suppressing nematodes is achieved by applying a composition comprising abamectin at a rate of from 7 to 10 grams/acre in combination with the application of water applied at a rate of from 8,500,000 to 103,000,000 grams/acre.

In another embodiment of the present technology, a method of controlling or suppressing nematodes is achieved by applying a composition comprising abamectin at a rate of from 5 to 30 grams/acre in combination with the application of water applied at a rate of from 10,000,000 to 26,500,000 grams/acre.

In another embodiment of the present technology, a method of controlling or suppressing nematodes is achieved by applying a composition comprising abamectin at a rate of from 7 to 15 grams/acre in combination with the application of water applied at a rate of from 10,000,000 to 26,500,000 grams/acre.

In another embodiment of the present technology, a method of controlling or suppressing nematodes is achieved by applying a composition comprising abamectin at a rate of from 7 to 10 grams/acre in combination with the application of water applied at a rate of from 10,000,000 to 26,500,000 grams/acre.

In another embodiment of the present technology, a method of controlling or suppressing nematodes is achieved by applying a composition comprising abamectin at a rate of from 5 to 30 grams/acre in combination with the application of water applied at a rate of from 15,000,000 to 25,000,000 grams/acre.

In another embodiment of the present technology, a method of controlling or suppressing nematodes is achieved by applying a composition comprising abamectin at a rate of from 7 to 15 grams/acre in combination with the application of water applied at a rate of from 15,000,000 to 25,000,000 grams/acre.

In another embodiment of the present technology, a method of controlling or suppressing nematodes is achieved by applying a composition comprising abamectin at a rate of from 7 to 10 grams/acre in combination with the application of water applied at a rate of from 15,000,000 to 25,000,000 grams/acre.

In another embodiment of the present technology, a method of controlling or suppressing nematodes is achieved by applying a composition comprising abamectin at a rate of from 8 to 9 grams/acre in combination with the application of water applied at a rate of from 15,000,000 to 25,000,000 grams/acre.

It is also shown in the data below that Treatment 2 generally outperformed Treatment 1 while delivering the same target rate of abamectin. While not being bound to particular theory, it is theorized that such improvement comes from the inclusion of Polysorbate 80 found in Treatment 2. Therefore, in another embodiment of the present technology the abamectin composition further comprises a polysorbate selected from polysorbate 20, polysorbate 40, polysorbate 60, or polysorbate 80. Polysorbates are generally used as emulsifiers and are derived from ethoxylated sorbitan esterified with fatty acids. Polysorbates are well known and sold under various brand names include TWEEN by Croda International, ALKEST by Oxiteno, and SCATTICS by Food Basics.

Additional embodiments of the present technology include a method of controlling or suppressing nematodes by applying a composition comprising abamectin and polysorbate in combination with water in the rate ranges of the embodiments below:

| | Abamectin | Polysorbate | Water |
|---|---|---|---|
| Embodiment | (g/acre) | (g/acre) | (g/acre) |
| x-1 | 5-30 | >1 | 8,500,000-103,000,000 |
| x-2 | 5-30 | >5 | 8,500,000-103,000,000 |
| x-3 | 5-30 | 1-1000 | 8,500,000-103,000,000 |
| x-4 | 7-15 | 1-1000 | 8,500,000-103,000,000 |
| x-5 | 7-10 | 1-1000 | 8,500,000-103,000,000 |
| x-6 | 8-9 | 1-1000 | 8,500,000-103,000,000 |
| x-7 | 5-30 | 1-500 | 8,500,000-103,000,000 |
| x-8 | 5-30 | 1-200 | 8,500,000-103,000,000 |
| x-9 | 5-30 | 5-100 | 8,500,000-103,000,000 |
| x-10 | 5-30 | 10-50 | 8,500,000-103,000,000 |
| x-11 | 5-30 | 15-30 | 8,500,000-103,000,000 |
| x-12 | 5-30 | 1-1000 | 10,000,000 to 26,500,000 |
| x-13 | 5-30 | 1-1000 | 15,000,000 to 25,000,000 |
| x-14 | 7-15 | 1-500 | 10,000,000 to 26,500,000 |
| x-15 | 7-15 | 5-100 | 10,000,000 to 26,500,000 |
| x-16 | 7-15 | 10-50 | 10,000,000 to 26,500,000 |
| x-17 | 7-10 | 1-500 | 10,000,000 to 26,500,000 |
| x-18 | 7-10 | 5-100 | 10,000,000 to 26,500,000 |
| x-19 | 7-10 | 10-50 | 10,000,000 to 26,500,000 |
| x-20 | 8-9 | 1-500 | 10,000,000 to 26,500,000 |
| x-21 | 8-9 | 5-100 | 10,000,000 to 26,500,000 |
| x-22 | 8-9 | 10-50 | 10,000,000 to 26,500,000 |
| x-23 | 7-15 | 1-500 | 15,000,000 to 25,000,000 |
| x-24 | 7-15 | 5-100 | 15,000,000 to 25,000,000 |
| x-25 | 7-15 | 10-50 | 15,000,000 to 25,000,000 |
| x-26 | 7-10 | 1-500 | 15,000,000 to 25,000,000 |
| x-27 | 7-10 | 5-100 | 15,000,000 to 25,000,000 |
| x-28 | 7-10 | 10-50 | 15,000,000 to 25,000,000 |
| x-29 | 8-9 | 1-500 | 15,000,000 to 25,000,000 |
| x-30 | 8-9 | 5-100 | 15,000,000 to 25,000,000 |
| x-31 | 8-9 | 10-50 | 15,000,000 to 25,000,000 |

Nematodes

The American Phytopathological Society estimates that nematodes account for approximately 14% of all worldwide plant losses, translating to $100 billion dollars annually.

Root-knot nematodes affect a vast amount of plant species are considered one of the most economically damaging nematodes. Root-knot nematodes, a common plant-parasitic nematode is from the genus Melodigoyne. Known root-knot nematode species include, among many others, M. javanica, M. arenaria, M. incognit, M. hapla and M. chitwoodi.

As further stated by the American Phytopathological Society “[Root-knot nematodes] can survive in temperate climates and can devastate crops grown in the tropics. Most root-knot nematodes also have extremely wide host ranges. Although it is difficult to ascertain the number of hosts for any one root-knot nematode species, it is likely that some root-knot nematodes can survive on hundreds of different plant species. This can make it extremely difficult to control a root-knot nematode problem, particularly if the nematode can survive on weeds. In addition, root-knot nematodes have repeatedly been shown to predispose their host plants to infection by other crop pathogens, increasing the potential for crop loss.”

Likewise, lesion nematodes (Genus: Pratylenchus), affect a great number of plant species are considered an economically damaging nematode. Known lesion nematode species include, among many others, P. neglectus, P. throne, P. teres, and P. penetrans.

As such, there remains a need for new and innovative methods of controlling and/or suppressing nematode populations.

### Examples/Trials

Nematode Counts:
For nematodes counts, five core samples, 12 inches in depth, and totaling 250 g soil were collected for each repetition and the live nematodes counted.

Nematode Species in Trials:
Root-Knot: Meloidogyne chitwoodi
Lesion: Pratylenchus neglectus

Treatments:
MINECTO PRO® and AGRIMEK®SC (produced by Syngenta Crop Protection, Greensboro, N.C.) were applied through a chemigation system to fallow ground infested with lesion and root-knot nematodes for evaluating control and suppression of nematodes.
MINECTO PRO® is an insecticide product containing abamectin and cyantraniliprole and used to control various insect pests. MINECTO PRO® contains 1.13 lbs of cyantraniliprole and 0.24 lbs of abamectin per gallon.
AGRIMEK® SC is a miticide/insecticide containing 0.7 lbs of abamectin per gallon. AGRIMEK® SC also contains 1.5 lbs per gallon of Polysorbate 80.
Application Rate:
Treatment 1: MINECTO PRO®—10 floz/acre delivering a target rate of 8.5 g abamectin/acre
Treatment 2: AGRIMEK®SC—3.5 floz/acre delivering a target rate of 8.5 g abamectin/acre

Trial 1:

Treatments 1 and 2 were each applied via chemigation, applying an equivalent of 5500 gals of water/acre (20,820,000 g of water/acre).

Trial 1 Schedule:
Day 0: Initial nematode counts and first application
of Treatments 1 and 2 thereafter.
Day 7: Second application of Treatments 1 and 2
Day 21: First post application nematode count (21/14 DAA)
Day 35: Second post application nematode count (35/28 DAA)
Trial 1 Results

| | | Root Knot Nematode | | | | |
|---|---|---|---|---|---|---|
| | | Count/250 g Dry Soil | | | % Reduction | |
| | | | 21/14 | 35/28 | 21/14 | 35/28 |
| Treatment | REP | Initial | DAA | DAA | DAA | DAA |
| Minecto Pro | 1 | 123 | 424 | 146 | −245% | −18% |
| Minecto Pro | 2 | 700 | 411 | 1098 | 41% | −57% |
| Minecto Pro | 3 | 759 | 1041 | 331 | −37% | 56% |
| Minecto Pro | 4 | 163 | 149 | 30 | 8% | 82% |
| Agrimek | 1 | 1080 | 589 | 76 | 45% | 93% |
| Agrimek | 2 | 743 | 156 | 525 | 79% | 29% |
| Agrimek | 3 | 260 | 19 | 28 | 93% | 89% |
| Agrimek | 4 | 678 | 287 | 44 | 58% | 93% |
| Untreated Check | 1 | 295 | 686 | 59 | −133% | 80% |
| Untreated Check | 2 | 128 | 170 | 195 | −33% | −53% |
| Untreated Check | 3 | 34 | 256 | 31 | −653% | 9% |

Trial 1 Results

| | | Lesion Nematode | | | | |
|---|---|---|---|---|---|---|
| | | Count/250 g Dry Soil | | | % Reduction | |
| | | | 21/14 | 35/28 | 21/14 | 35/28 |
| Treatment | REP | Initial | DAA | DAA | DAA | DAA |
| Minecto Pro | 1 | 78 | 156 | 114 | −99% | −47% |
| Minecto Pro | 2 | 8 | 75 | 29 | −838% | −257% |
| Minecto Pro | 3 | 7 | 76 | 11 | −983% | −60% |
| Minecto Pro | 4 | 111 | 158 | 108 | −43% | 3% |
| Agrimek | 1 | 6 | 14 | 7 | −137% | −10% |
| Agrimek | 2 | 0 | 55 | 5 | N/A | N/A |
| Agrimek | 3 | 49 | 188 | 30 | −283% | 38% |
| Agrimek | 4 | 85 | 32 | 25 | 62% | 70% |
| Untreated Check | 1 | 0 | 7 | 9 | N/A | N/A |
| Untreated Check | 2 | 70 | 549 | 43 | −685% | 38% |
| Untreated Check | 3 | 28 | 242 | 39 | −766% | −40% |

Trial 2:

Treatments 1 and 2 were each applied via chemigation, applying an equivalent of 5500 gals of water/acre (20,820,000 g of water/acre).

Trial 2 Schedule
Day 0: Initial nematode counts
Day 14: First application of Treatments 1 and 2
Day 21: Second application of Treatments 1 and 2
Day 56: Post application nematode count (42/35 DAA)
Trial 2 Results

| | | Root-Knot Nematode | | |
|---|---|---|---|---|
| | | Count/250 g Dry Soil | | % Reduction |
| Treatment | REP | Initial | 42/35 DAA | 42/35 DAA |
| Minecto Pro | 1 | 7 | 3 | 52% |
| Minecto Pro | 2 | 14 | 13 | 10% |
| Minecto Pro | 3 | 26 | 3 | 87% |
| Minecto Pro | 4 | 420 | 25 | 94% |
| Agrimek | 1 | 9 | 4 | 49% |
| Agrimek | 2 | 12 | 2 | 82% |
| Agrimek | 3 | 26 | 9 | 66% |
| Agrimek | 4 | 65 | 15 | 77% |
| Untreated Check | 1 | 6 | 12 | −113% |
| Untreated Check | 2 | 25 | 14 | 44% |
| Untreated Check | 3 | 40 | 7 | 84% |
| Untreated Check | 4 | 144 | 1 | 99% |

Trial 2 Results

| | | Lesion Nematode | | |
|---|---|---|---|---|
| | | Count/250 g Dry Soil | | % Reduction |
| Treatment | REP | Initial | 42/35 DAA | 42/35 DAA |
| Minecto Pro | 1 | 152 | 344 | −126% |
| Minecto Pro | 2 | 81 | 102 | −26% |
| Minecto Pro | 3 | 1169 | 2302 | −97% |
| Minecto Pro | 4 | 79 | 569 | −621% |
| Agrimek | 1 | 116 | 149 | −28% |
| Agrimek | 2 | 139 | 591 | −327% |
| Agrimek | 3 | 246 | 1351 | −450% |
| Agrimek | 4 | 125 | 191 | −53% |
| Untreated Check | 1 | 994 | 1132 | −14% |
| Untreated Check | 2 | 104 | 664 | −539% |
| Untreated Check | 3 | 562 | 1659 | −195% |
| Untreated Check | 4 | 887 | 4467 | −404% |

1. A method for controlling or suppressing nematodes, the method comprising:
applying, to the soil of a field having nematodes, a composition comprising abamectin and water, wherein the abamectin is applied at a rate of from 5 to 30 grams/acre and the water is applied at a rate of from 8,500,000 to 103,000,000 grams/acre.

2. The method of claim 1, wherein the composition further comprises a polysorbate.

3. The method of claim 2, wherein the polysorbate is polysorbate 20, polysorbate 40, polysorbate 60, or polysorbate 80.

4. The method of claim 2, wherein the polysorbate is applied at a rate of from 1 to 1000 grams/acre.

5. The method of claim 2, wherein the abamectin is applied at a rate of from 7 to 15 grams/acre; the water is applied at a rate of from 10,000,000 to 26,500,000 grams/acre; and the polysorbate is applied at a rate of from 5 to 100 grams/acre.

6. The method of claim 1 wherein the nematode is a root-knot nematode.

7. The method of claim 5 wherein the nematode is a root-knot nematode.

8. A method of controlling or suppressing nematodes, the method comprising:
applying, to the soil of a field having nematodes, a composition comprising (i) a pesticide consisting essentially of abamectin, and (ii) water, wherein the abamectin is applied at a rate of from 5 to 30 grams/acre and the water is applied at a rate of from 8,500,000 to 103,000,000 grams/acre.

9. The method of claim 8, wherein the composition further comprises a polysorbate.

10. The method of claim 9, wherein the polysorbate is polysorbate 20, polysorbate 40, polysorbate 60, or polysorbate 80.

11. The method of claim 9, wherein the polysorbate is applied at a rate of from 1 to 1000 grams/acre.

12. The method of claim 9, wherein the abamectin is applied at a rate of from 7 to 15 grams/acre; the water is applied at a rate of from 10,000,000 to 26,500,000 grams/acre; and the polysorbate is applied at a rate of from 5 to 100 grams/acre.

13. The method of claim 8 where the nematode is a root-knot nematode.

14. The method of claim 12 where the nematode is a root-knot nematode.

15. A method controlling or suppressing nematodes, the method comprising:
applying, to the soil of a field having nematodes, a composition comprising abamectin and water, wherein the abamectin is applied at a rate of from 5 to 30 grams/acre and the water is applied at a rate of from 8,500,000 to 103,000,000 grams/acre, with the proviso that the composition does not contain cyantraniliprole.

16. The method of claim 15, wherein the composition further comprises a polysorbate.

17. The method of claim 16, wherein the polysorbate is polysorbate 20, polysorbate 40, polysorbate 60, or polysorbate 80.

18. (canceled)

19. The method of claim 15, wherein the abamectin is applied at a rate of from 7 to 15 grams/acre; the water is applied at a rate of from 10,000,000 to 26,500,000 grams/acre; and the polysorbate is applied at a rate of from 5 to 100 grams/acre.

20. (canceled)

21. (canceled)

22. The method of claim 1, wherein the composition is applied through an irrigation system.

23. The method of claim 22, wherein the irrigation system is a center pivot or lateral irrigation system.

24. (canceled)
